(19) United States
(12) Patent Application Publication
(10) Pub. No.: US 2018/0033031 A1
(43) Pub. Date: Feb. 1, 2018

(54) EVALUATION ESTIMATION APPARATUS CAPABLE OF ESTIMATING EVALUATION BASED ON PERIOD SHIFT CORRELATION, METHOD, AND COMPUTER-READABLE STORAGE MEDIUM

(71) Applicant: KDDI CORPORATION, Tokyo (JP)

(72) Inventors: Akihiro Kobayashi, Fujimino-shi (JP); Naoki Imai, Fujimino-shi (JP)

(21) Appl. No.: 15/658,764

(22) Filed: Jul. 25, 2017

(30) Foreign Application Priority Data
Jul. 28, 2016 (JP) 2016-149026

(51) Int. Cl. G06Q 30/02

(52) U.S. Cl. CPC G06Q 30/0203; G06Q 30/0282; G06Q 50/01

(57) ABSTRACT

An evaluation estimation apparatus includes: a document totaling unit configured to, for each predetermined unit period, associate, with the predetermined unit period, document information concerning a document which is generated during the predetermined unit period and related to the evaluation target; and an evaluation estimation unit configured to use a period shift amount determined based on a degree of correlation between the document information whose associated unit period has been shifted by each of a plurality of shift amounts and the evaluation information acquired for each unit period to input document information of a document associated with a unit period that corresponds to an estimation target period when shifted by the determined period shift amount, and output an evaluation value of the evaluation target during the estimation target period.

### CROSS-REFERENCE TO RELATED APPLICATION

This application is based upon and claims the benefit of priority from the prior Japanese Patent Application No. 2016-149026, filed on Jul. 28, 2016, the entire contents of which are incorporated herein by reference.

### BACKGROUND OF THE INVENTION

### Field of the Invention

The present invention relates to a technique of analyzing a document acquired on a communication network service.

### Description of the Related Art

In recent years, an enormous number of users use an SNS (Social Networking Service), and post and reveal, as posters, comments, opinions, and the like about various topics. Many of the enormous number of posts include evaluations about products and services provided by companies, that is, word-of-mouth information.

Therefore, these days, many companies have extensively studied whether it is possible to acquire useful information about images/evaluation with respect to products and services provided by them by analyzing the posts of the users on the SNS.

In this point, a method that uses information acquired on the SNS can collect pieces of information about products and services efficiently at a very low cost, as compared with a conventional method of distributing a questionnaire to the users.

As a practical example of the technique of using information on the SNS, Japanese Patent Laid-Open No. 2013-196070 discloses a technique of estimating, by using information about the relationship between posters obtained from an SNS site server, a group into which a poster is classified based on attributes such as an age and sex.

However, in the technique described in Japanese Patent Laid-Open No. 2013-196070, it is very difficult to appropriately estimate an evaluation, for example a brand image, which users have of a product or service provided by a company.

Today, it is very important to quantify a brand image which general users have of a brand of the company in terms of marketing strategies. For example, NPS (Net Promotion Score) is known as the quantified value of the brand image. Conventionally, however, the NPS is calculated not by using posts acquired on the SNS but by distributing a questionnaire to a number of users by spending a lot of money after all.

One reason why posts on the SNS cannot be used for quantification of a brand image is the time difference of evaluation. Information (post contents) generally spreads almost in real time on the SNS. On the other hand, a brand image is considered to be firmly established long after the information is sent, in many cases, much later.

Therefore, there is no solution at all for a determination of a specific type of posts during a specific sending period, which need to be collected and analyzed to estimate a brand image, among an enormous number of posts on the SNS.

### SUMMARY OF THE INVENTION

According to one aspect of the present invention, there is provided an evaluation estimation apparatus for estimating evaluation of a predetermined evaluation target based on a document acquired from a document set on a network and evaluation information concerning evaluation of the evaluation target that is acquired in advance. The apparatus includes: a document totaling unit configured to, for each predetermined unit period, associate, with the predetermined unit period, document information concerning a document which is generated during the predetermined unit period and related to the evaluation target; and an evaluation estimation unit configured to use a period shift amount determined based on a degree of correlation between the document information whose associated unit period has been shifted by each of a plurality of shift amounts and the evaluation information acquired for each unit period to input document information of a document associated with a unit period that corresponds to an estimation target period when shifted by the determined period shift amount, and output an evaluation value of the evaluation target during the estimation target period.

Further features of the present invention will become apparent from the following description of exemplary embodiments with reference to the attached drawings.

### BRIEF DESCRIPTION OF THE DRAWINGS

FIG. 1 is a schematic view showing an embodiment of an evaluation estimation system including an evaluation estimation apparatus according to the present invention;

FIG. 2 is a functional block diagram showing the functional arrangement of an embodiment of the evaluation estimation apparatus according to the present invention;

FIG. 3 is a schematic view showing an embodiment of an SNS totaling set and an SNS period shift totaling set;

FIG. 4 is a schematic view showing an embodiment of a questionnaire totaling set, correlation calculation processing in a correlation calculation unit, a period shift model, and an SNS period shift corrected totaling set;

FIG. 5 is a schematic view for explaining an embodiment of learning processing and estimation processing in an evaluation estimation engine;

FIG. 6 is a functional block diagram showing the functional arrangement of another embodiment of the evaluation estimation apparatus according to the present invention; and

FIGS. 7A and 7B are graphs for explaining an example of an evaluation estimation method according to the present invention.

### DESCRIPTION OF THE EMBODIMENTS

Embodiments of the present invention will be described in detail below with reference to the accompanying drawings.

[Evaluation Estimation System]

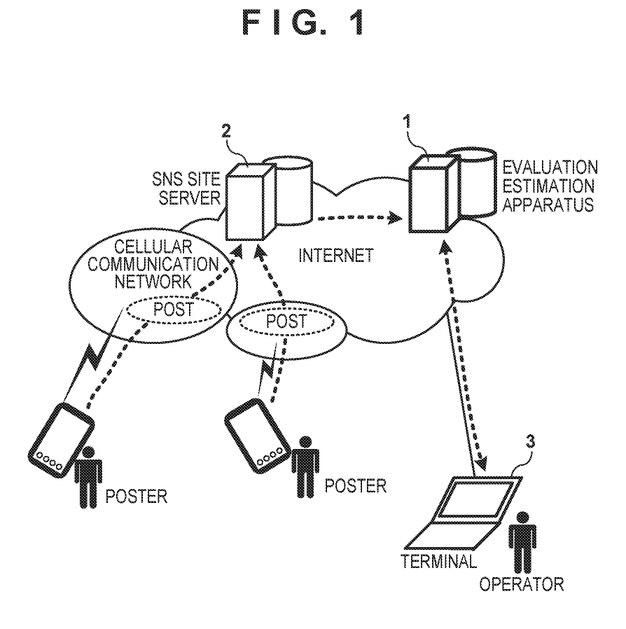

FIG. 1 is a schematic view showing an embodiment of an evaluation estimation system including an evaluation estimation apparatus.

Referring to FIG. 1, a number of SNS users transmit, as posters, posts created by themselves to an SNS site server 2 via the Internet or an access network such as a cellular communication network using terminals. The server as the transmission destination of the posts is not limited to the SNS site server, and may be, for example, a so-called communication site server.

The SNS site server 2 transmits the received post to the terminals of users who belong to a set predetermined group or to unspecific users. This implements a communication service via posts between the users.

An evaluation estimation apparatus 1 shown in FIG. 1 according to this embodiment is configured to be communicable with the SNS site server 2 via the Internet. More specifically, the evaluation estimation apparatus 1 may include an API (Application Programming Interface) prepared in accordance with the server type of the SNS site server 2, and may be able to acquire, for each poster, from the server 2, information about a group to which the poster belongs and a post sent by the poster.

Note that as a modification, the evaluation estimation apparatus 1 may acquire a post and information about it from not the SNS site server 2 but from an internal or external database in which such pieces of information are accumulated in advance.

In this embodiment, information processing related to evaluation estimation in the evaluation estimation apparatus 1 is executed under the control of a terminal 3 operated by an operator. The evaluation estimation apparatus 1 may be controlled in another known control form, as a matter of course. In either case, in this embodiment, a computer on which an evaluation estimation program is installed according to the present invention can be used as the evaluation estimation apparatus 1. The evaluation estimation program may be stored in a non-transitory computer-readable storage medium, and installed to the computer having one or more processors. The one or more processors executes the evaluation estimation program.

The evaluation estimation apparatus 1 according to the present invention has a function of estimating an evaluation of a predetermined evaluation target (for example, a product or service provided by a given company) based on

(a) a document acquired from a document set such as SNS posts on the network, and
(b) evaluation information (for example, an evaluation value based on a questionnaire result), acquired in advance, about the evaluation of the evaluation target.

More specifically, the evaluation estimation apparatus 1 has as its feature to

(A) associate, for each predetermined unit period (for example, each week forming a predetermined period), with the unit period, document information (for example, an SNS post count) about documents (for example, SNS posts) which are generated during the unit period and are related to the evaluation target,
(B1) use a “period shift amount” determined based on the degree of correlation between document information whose associated unit period has been shifted by each of a plurality of shift amounts and evaluation information acquired for each unit period, for example, the magnitude of a correlation value (correlation coefficient), and
(B2) input document information of a document associated with a unit period which corresponds to an estimation target period (for example, one week from July 1) when shifted by the determined “period shift amount”, and output an evaluation value of the evaluation target during the estimation target period.

The evaluation estimation apparatus 1 can provide an appropriate evaluation value of the evaluation target during the estimation target period using the “period shift amount” determined based on the correlation in consideration of a “shift” in information generation time between the document information (for example, the SNS post count) and the evaluation information (for example, the evaluation value based on the questionnaire result).

As a preferred embodiment, in (A) above, for each unit period for each of a plurality of preset document classifications (for example, attribute groups to which the posters belong), document information (for example, an SNS post count) concerning documents (for example, SNS posts) belonging to the document classification is preferably associated with the unit period.

In this embodiment, in (B1) above, the “document classification” and the “period shift amount” determined based on the degree of correlation between the document information concerning documents belonging to each document classification, whose associated unit period has been shifted by each of the plurality of shift amounts, and the evaluation information acquired for each unit period, for example, the correlation value are used. Then, in (B2) above, the document information of the documents belonging to the determined “document classification”, which is associated with the unit period that corresponds to the estimation target period when shifted by the determined “period shift amount”, is input, and the evaluation value of the evaluation target during the estimation target period is output.

For example, as a practical example, if the evaluation target is “smartphone α” and the evaluation target period is the “fourth week of July”, a period shift amount “three weeks” determined based on the above correlation and a document classification “30's male group” are used to input an SNS post count xx (document information), associated with the first (=4−3) week of July, by posters who are males in their 30's, thereby making it possible to output a brand score (evaluation value) of “smartphone α” in the “fourth week of July”.

In general, an image of a given product or service, or an image of one brand is considered to be firmly established for general users long after a post about such image appears on the SNS, in many cases, much later. For example, a post including negative contents generally spreads in a short time, as compared with a post including positive contents. Therefore, the time difference (period shift amount) between a point of time at which a product/service (brand) image formed by the influence of a post including negative contents is firmly established and a point of time at which the post is sent is considered to be relatively small. That is, if the document classification is “polarity of post contents: negative”, the time shift amount has a smaller value.

If the poster of a post associated with the SNS post count processed as document information belongs to, for example, the early adopters, that is, the document classification is “early adopter group”, the delay (positive period shift amount) of the point of time at which the product/service (brand) image is firmly established is larger than that when the poster belongs to the early majority. This is because a comment of the early adopters on the SNS is sent earlier than the point of time at which the product/service (brand) image is generally established.

Therefore, even if pieces of information of SNS posts are collected, and the correlation between the pieces of post information and, for example, a brand image is simply checked, it is very difficult to find the correlation which can be used for evaluation estimation.

To the contrary, the evaluation estimation apparatus according to the present invention can estimate a more appropriate evaluation value according to the realities by considering the time difference between the point of time at which such document information (for example, the SNS post count) is generated and the point of time at which the evaluation information (for example, the product/service (brand) image score) is generated, using the “period shift amount” determined based on the correlation between the pieces of information.

Especially, in the embodiment, considering the document classification of the document information, a document classification based on user attributes and document contents (for example, the polarity) is set, and the “period shift amount” determined in accordance with the document classification is used, thereby making it possible to estimate a more appropriate evaluation value according to the realities of the period shift for each document classification. For example, it is possible to estimate a brand image evaluation value based on information of an SNS post in consideration of an influence delay according to a group to which an SNS poster belongs and the polarity of post contents.

[Embodiment of Apparatus Arrangement]

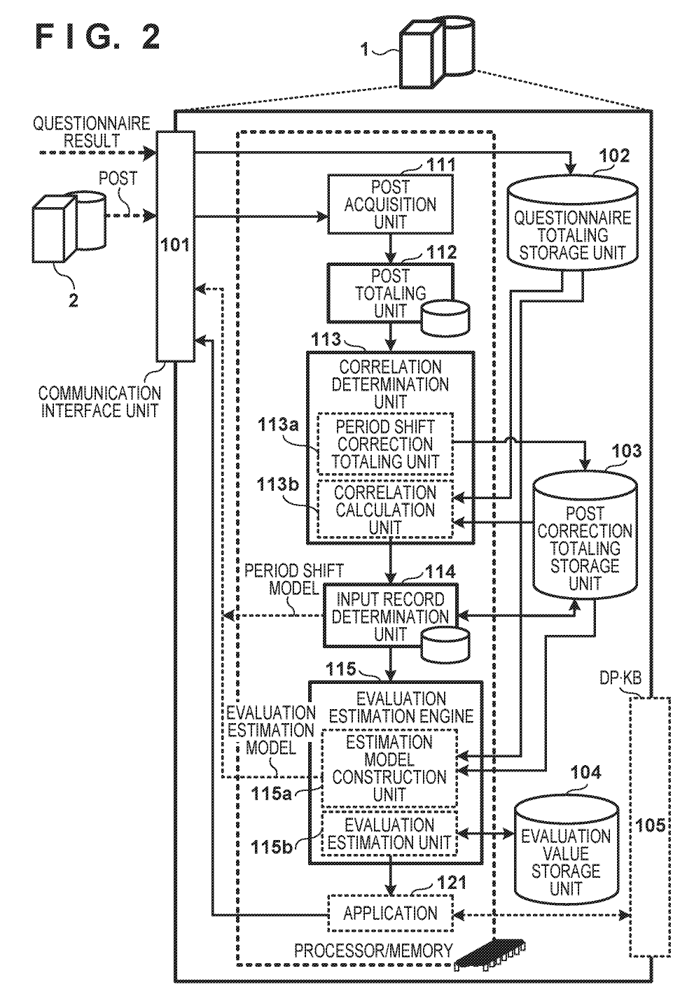

FIG. 2 is a functional block diagram showing the functional arrangement of an embodiment of the evaluation estimation apparatus according to the present invention.

Referring to FIG. 2, the evaluation estimation apparatus 1 includes a communication interface unit 101, a questionnaire totaling storage unit 102, a post correction totaling storage unit 103, an evaluation value storage unit 104, a display and keyboard (DP/KB) 105, and a processor/memory. The processor/memory implements an evaluation estimation function by executing a program for causing the computer of the evaluation estimation apparatus 1 to function.

Furthermore, the processor/memory includes, as functional components, a post acquisition unit 111, a post totaling unit 112, a correlation determination unit 113, an input record determination unit 114, an evaluation estimation engine 115, and an application 121. A processing procedure indicated by connecting the functional components of the apparatus 1 by arrows in FIG. 2 is understood as an embodiment of an evaluation estimation method according to the present invention.

Referring to FIG. 2, the post acquisition unit 111 acquires an SNS post (posted text) as a document on the network from the SNS site server 2 via the communication interface unit 101. The acquired SNS post is preferably associated with sending (post) date/time information and attribute group information of the poster (for example, the generation/age, sex, and the like of the poster). Furthermore, the apparatus 1 preferably acquires, from, for example, the terminal 3 (FIG. 1) or another external server via the communication interface unit 101, information of the result of a questionnaire which has been distributed in advance to general users.

For each unit period for each of a plurality of preset document classifications (for example, classifications of ages and sexes of SNS posters), the post totaling unit 112 associates, with the unit period, document information (for example, the SNS post count) concerning SNS posts which are generated during the unit period, are associated with the evaluation target (for example, “smartphone α”), and belong to the document classification.

In this example, a post containing the name of the evaluation target can be considered as a post associated with the evaluation target. Alternatively, a post containing a predetermined number of keywords among at least one preset keyword associated with the evaluation target can be considered as a post associated with the evaluation target.

Each document classification pertains to

(a) a document creation entity (for example, a poster), and/or
(b) document contents (for example, post contents) concerning evaluation. For (a), for example, classifications such as “30's male” and “20's female” can be set. For (b), for example, classifications such as “polarity of post contents: positive” and “polarity of post contents: neutral” can be set.

The polarity information of post contents can be acquired by, for example, a known method using the morphological analysis result of posted text and a polarity word dictionary. Alternatively, polarity information may be externally determined for a post acquired from the SNS site server 2, and the post linked with the polarity information may be acquired. Note that the document classifications are not limited to the above-described ones, as a matter of course. Various items which can characterize a document (post) can be adopted as document classifications.

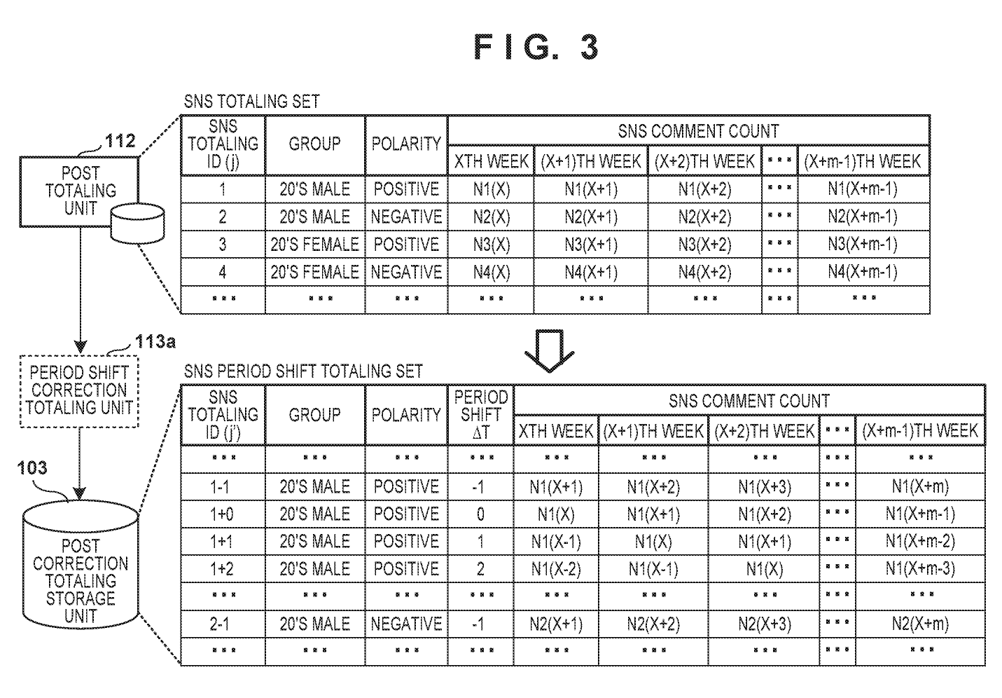

As a practical example, as shown in FIG. 3, the post totaling unit 112 generates an SNS totaling set by associating, with each other, information of a poster attribute classification, information of a post contents polarity classification, and the number of SNS posts (the number of comments) generated for each unit period as document information.

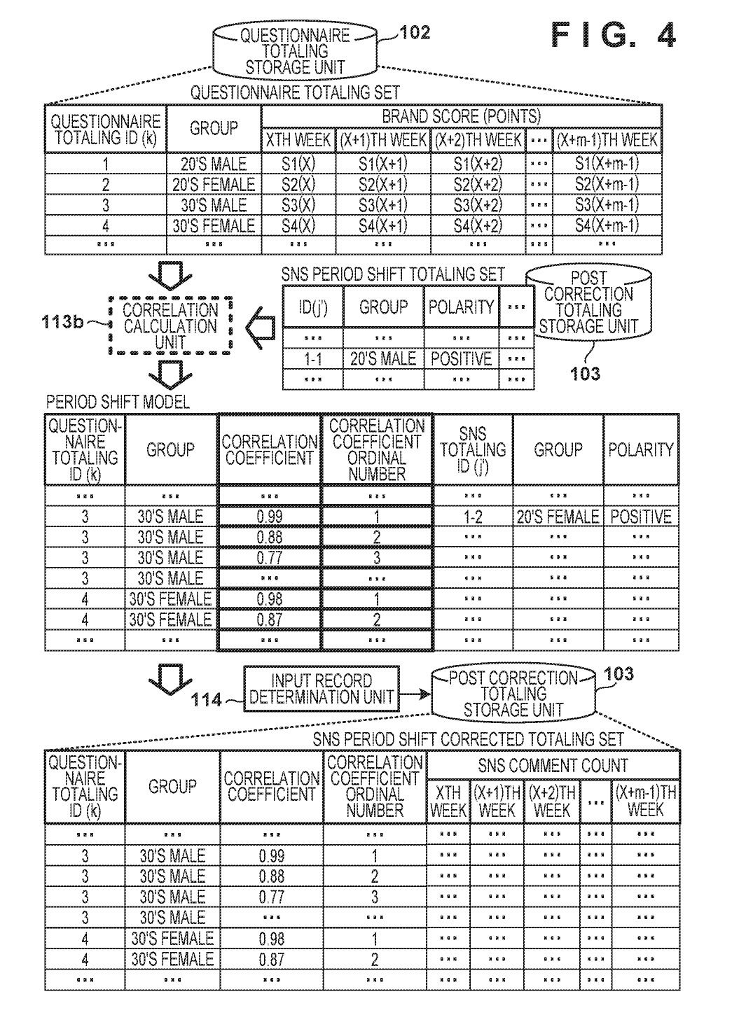

The questionnaire totaling storage unit 102 generates a questionnaire totaling set by collecting pieces of information of acquired questionnaire results, and stores it. Alternatively, the questionnaire totaling storage unit 102 may acquire an externally generated questionnaire totaling set, and store it. FIG. 4 shows a practical example of the questionnaire totaling set. The questionnaire totaling set can be stored in a table in which the totaled value of brand scores (evaluation values) for each unit period associated with totaling is recorded in association with each questionnaire target attribute, for example, each set of the age and sex of questionnaire respondents.

Referring to FIG. 2, the correlation determination unit 113 shifts the associated unit period of the SNS post count (as document information) by each of the plurality of shift amounts, and calculates, for each shift amount used for the shift operation and each document classification (each set of an age/sex classification and a post contents polarity classification), the correlation between the SNS post count associated with each unit period and the evaluation value (as evaluation information) acquired for each unit period.

More specifically, the correlation determination unit 113 preferably includes a period shift correction totaling unit 113a and a correlation calculation unit 113b, as shown in FIG. 2. The period shift correction totaling unit 113a generates an SNS period shift totaling set by shifting, by each of the plurality of shift amounts, the associated unit period of the SNS post count in the generated SNS totaling set. A practical example of the SNS period shift totaling set will be described in detail later with reference to FIG. 3. Note that the generated SNS period shift totaling set is preferably accumulated in the post correction totaling storage unit 103.

With respect to setting of the unit period, each of continuous (non-overlapping) “weeks” like the first week, second week, . . . of a given month can be set as a unit period. As a modification, it is possible to set, as a unit period, each of continuous “weeks” having overlapping periods like one week from given Monday, one week from Tuesday as the next day, . . . .

Note that if the unit periods having overlapping periods are set, for example, when −1 week, 0 week, and +1 week are set as the “plurality of shift amounts”, one unit period “one week from Tuesday” is shifted to each of “one week from last Tuesday”, “one week from the same Tuesday”, and “one week from next Tuesday” in accordance with each of the shift amounts. This generates three records from one record. If such unit periods are set, it is preferably possible to set the unit periods of the questionnaire totaling set accordingly in order to appropriately perform correlation calculation processing later in the correlation calculation unit 113b.

Furthermore, the time length of the set unit period is not limited to one week, as a matter of course. For example, a period of a day, a month, half a year, or a year can be set as a unit period.

On the other hand, as will be described in detail later with reference to FIG. 4, the correlation calculation unit 113b calculates, for each shift amount and each document classification (for example, each set of an age/sex classification and a post contents polarity classification), the correlation between the SNS post count associated with each unit period and the evaluation value (brand score) acquired for each unit period, using the generated questionnaire totaling set and SNS period shift totaling set.

As shown in FIG. 4, the correlation determination unit 113 generates, for each record of the questionnaire totaling set, a “period shift model” by associating the calculated correlation value (correlation coefficient) with the ordinal number of the magnitude of the value.

Based on the degree of correlation calculated for each shift amount (for example, each of −1 week, 0 week, +1 week, and +2 weeks) and each document classification (for example, each set of an age/sex classification and a post contents polarity classification), for example, based on the correlation value (correlation coefficient), the input record determination unit 114 determines

(a) a document classification (for example, a set of an age/sex classification and a polarity classification) pertaining to the document information, and
(b) the period shift amount to be used for the associated unit period of the SNS post count, both of which are to be input to the evaluation estimation engine 115.

More specifically, the input record determination unit 114 may generate, as shown in FIG. 4, an SNS period shift corrected totaling set based on the “period shift model” generated by the correlation determination unit 113, and determine at least one set of a document classification (for example, a set of an age/sex classification and a polarity classification) and a period shift amount in descending order of the calculated correlation. The generated SNS period shift corrected totaling set is preferably accumulated in the post correction totaling storage unit 103.

FIG. 3 is a schematic view showing an embodiment of the SNS totaling set and SNS period shift totaling set.

FIG. 3 shows a practical example of the SNS totaling set generated by the post totaling unit 112. In this SNS totaling set, a post group belonging to each set of a poster age/sex classification and a polarity classification (positive/negative) as a document classification is set as a record, and an SNS totaling identifier (ID) “j” is assigned to each record. For each SNS totaling ID “j”, SNS post counts (comment counts) for respective weeks (the Xth week, (X+1)th week, (X+2)th week, . . . , (X+m)th week) as unit periods are recorded in association with the SNS totaling ID “j”.

A record jᵢ whose totaling ID “j” is “i” in the SNS totaling set can be represented by, for example,

(1) j₁=(20's, male, positive)
j₂=(20's, male, negative)
. . . .

FIG. 3 shows a practical example of the SNS period shift totaling set generated by the period shift correction totaling unit 113a. In this SNS period shift totaling set,

(a) for each set of a poster age/sex classification and a polarity classification (positive/negative) as a document classification, and
(b) for each shift amount ΔT used for the shift operation,

a post group belonging to the document classification and shift amount is set as a record, and an SNS totaling ID “j′” is assigned to each record. Next, for each SNS totaling ID “j′”, SNS post counts (comment counts) for the respective weeks (the Xth week, (X+1)th week, (X+2)th week, . . . , (X+m)th week) as unit periods are recorded in association with the SNS totaling ID “j′”.

A record j′ᵢ whose totaling ID “j′” is “i” in the SNS period shift totaling set is, for example, j′ᵢ=(jᵢ, ΔT) represented by

(2) j′₁₋₁=(20's, male, positive, −1)
j′₁₊₀=(20's, male, positive, 0)
j′₁₊₁=(20's, male, positive, +1)
. . . .

FIG. 4 is a schematic view showing an embodiment of the questionnaire totaling set, the correlation calculation processing in the correlation calculation unit 113b, the period shift model, and the SNS period shift corrected totaling set.

FIG. 4 shows a practical example of the questionnaire totaling set accumulated in the questionnaire totaling storage unit 102. In this questionnaire totaling set, the average value of the response results of questionnaire respondents belonging to each respondent age/sex classification, that is, the average value of brand scores (evaluation values) is set as a record, and a questionnaire totaling ID “k” is assigned to each record. For each questionnaire totaling ID “k”, the totaled values of the brand scores (evaluation values) for the respective weeks (the Xth week, (X+1)th week, (X+2)th week, . . . , (X+m)th week) as unit periods are recorded in association with the questionnaire totaling ID “k”. A record whose totaling ID “k” is “l” is represented by kₗ.

Each record (each row) of the questionnaire totaling set is characterized by the respondent age/sex classification. However, the present invention is not limited to this, as a matter of course. Each record may be characterized by an evaluation classification pertaining to an evaluation entity and/or evaluation contents. Evaluation information, for example, positive, negative, or neutral polarity information other than the brand score (evaluation value) may be adopted as a record.

As for the evaluation value, for example, the known NPS (Net Promotion Score) can be adopted as the brand score. However, the present invention is not limited to this. For example, an evaluation value obtained by simply evaluating the popularity on a scale of 1 to N may be adopted.

Referring to FIG. 4, the correlation calculation unit 113b obtains the correlation between the totaled brand score (evaluation value) and the SNS post count (comment count) using the questionnaire totaling set and the SNS period shift totaling set (FIG. 3) accumulated in the post correction totaling storage unit 103.

More specifically, the correlation calculation unit 113b calculates the correlations for all combinations of

(a) records j′ᵢ of the SNS period shift totaling set, and
(b) records kₗ of the questionnaire totaling set, and determines, for each questionnaire totaling ID “k”, a predetermined number of records j′ᵢ, including the record j′ᵢ having the largest correlation value (correlation coefficient), in descending order of the correlation values.

The correlation is calculated for a summation for m between

(a1) the SNS post count x(m, i) during the mth (m=1, 2, . . . , M) week (unit period) in the record j′ᵢ and
(b1) the brand score y(m, 1) during the mth (m=1, M) week (unit period) in the record k₁.

In general, the correlation value (correlation coefficient) r between the two data rows {xₘ} and {yₘ} (m=1, M) is calculated by

r=(Σₘ₌₁^{M}(xₘ−x_{AV})·(yₘ−y_{AV}))·(Σₘ₌₁^{M}(xₘ−x_{AV})²)^{-0.5}·(Σₘ₌₁^{M}(yₘ−y_{AV})²)^{-0.5} (3)

where x_{AV}=Σₘ₌₁^{M}xₘ/m and y_{AV}=Σₘ₌₁^{M}yₘ/m. In addition, Σₘ₌₁^{M} represents a summation for m.

The correlation calculation unit 113b can calculate correlation values r(i, l) for all combinations of the records j′ᵢ of the SNS period shift totaling set and the records k₁ of the questionnaire totaling set by applying equation (3) above.

Then, for one questionnaire totaling ID “k”, by using a map function J,
the record j′ᵢ having the largest absolute value of the calculated correlation value r is J(1, k),
the record j′ᵢ having the second largest absolute value of the calculated correlated value r is J(2, k),
   . . .
the record j′ᵢ having the nth largest absolute value of the calculated correlated value r is J(n, k).
   The record J(n, k) serves as a “period shift model” for implementing period correction by a period shift.

That is, the period shift model J(n, k) is obtained by saving, in association with each other, a combination of j (SNS totaling ID) and AT (shift amount) having a high correlation and the correlation value r for all k (questionnaire totaling IDs). For example, as a practical example, in the period shift model J(n, k),

$$\begin{matrix}J ( 1 , 1 ) = J ( 1 , {30}^{′} s , male ) \\ = ( j = 5 , + 2 , r ) \\ = ( {20}^{′} s , female , positive , + 2 , r ( k = 1 , j = 5 , + 2 ) )\end{matrix} \qquad ( 4 )$$

This indicates that a record obtained by totaling positive posts (j=5) by females in their 20's by delaying the unit period by +2 (that is, by two weeks) as a (period) shift amount is a record in which the SNS post count has the highest correlation with the questionnaire score of males in their 30's (k=1).

FIG. 4 shows a practical example of the generated period shift model J(n, k). In FIG. 4, in the period shift model J(n, k), for each k (questionnaire totaling ID), the number of records of pieces of SNS period shift totaling information, which is equal to the number of correlation value ordinal numbers n, are saved.

Next, the input record determination unit 114 functions as a period shift corrector, and generates an SNS period shift corrected totaling set shown in FIG. 4 based on the generated period shift model and the SNS period shift totaling set (FIG. 3).

More specifically, in the SNS period shift corrected totaling set, for each k (questionnaire totaling ID), N SNS post count records suitable for evaluation value estimation are selected in descending order of the calculated correlation values r, and saved. The period shift model J(n, k) is given to the input record determination unit 114 serving as the period shift corrector, and thus the SNS post count during the mth (m=1, 2, . . . , M) week (unit period) is given by x(m, J(n, k)). In this example, since there exist the models J(n, k), the number of which is equal to the number N*K of combinations of correlation value ordinal numbers n and k (questionnaire totaling IDs), N*K SNS post counts x(m, i) are generated.

As described above with reference to FIGS. 3 and 4, this embodiment has a feature in which the “period shift model J(n, k)” considering the period shift amount determined based on the correlation is generated. By adopting the period shift model J(n, k), it is possible to estimate an appropriate evaluation value (brand score) according to the realities during a predetermined evaluation target period even if, for example, a known regression estimation model is applied.

Referring back to FIG. 2, the evaluation estimation engine 115 includes an estimation model construction unit 115a and an evaluation estimation unit 115b. The estimation model construction unit 115a generates an evaluation estimation model using

(a) a post count (as document information) whose associated unit period has been shifted by the “period shift amount” determined by the input record determination unit 114 and which concerns SNS posts belonging to each document classification (each set of an age/sex classification and polarity classification), and
(b) a brand score (as evaluation information) associated with the same unit period as that of the shift result.

On the other hand, using

(a) “the period shift amount” and
(b) “the document classification (age/sex classification and polarity classification)”, both of which have been determined by the input record determination unit 114, the evaluation estimation unit 115b inputs, to the generated evaluation estimation model, the SNS post count (as document information) which is associated with the unit period that corresponds to the estimation target period when shifted by the determined “period shift amount” and which is the number of SNS posts belonging to the determined “document classification”, and outputs the evaluation value (brand score) of the evaluation target (for example, “smartphone α”) during the estimation target period.

It is preferable that the evaluation value (brand score) estimated by the evaluation estimation engine 115 is accumulated in the evaluation value storage unit 104, processed by the application 121 to be collected as, for example, a brand image estimation result, and displayed on the display 105 in response to, for example, an input from the keyboard 105. The application 121 may have a function of generating or selecting advertisement information suitable for transition of the brand score. In this case, the application 121 may output advertisement information in accordance with the evaluation value (brand score) input during the predetermined period, and externally transmit it via, for example, the communication interface unit 101.

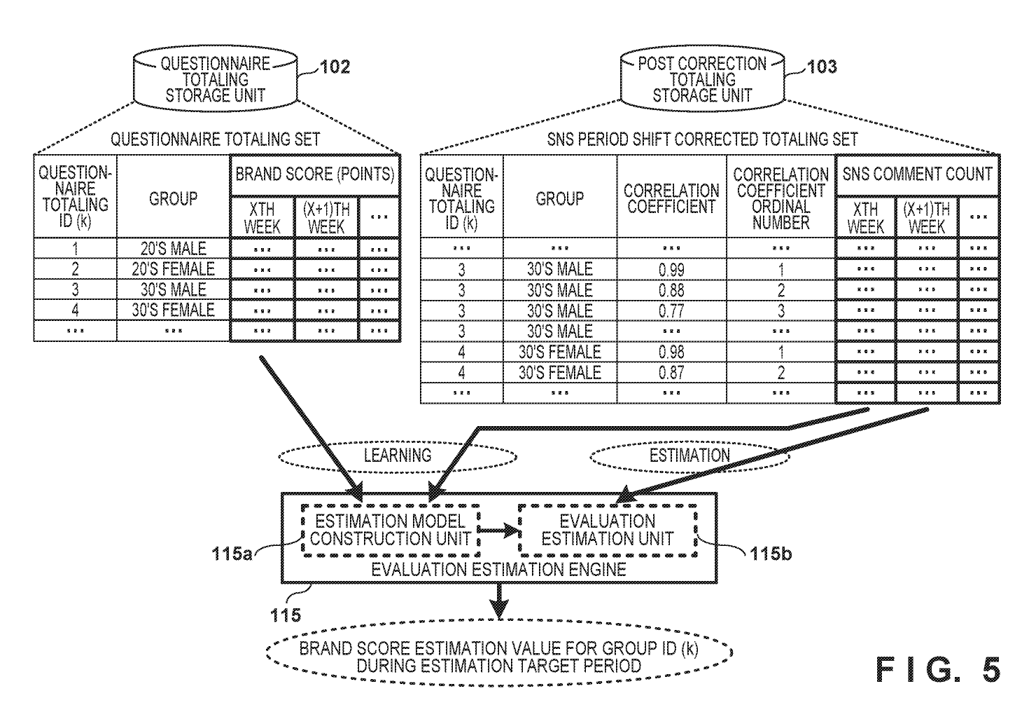

FIG. 5 is a schematic view for explaining an embodiment of learning processing and estimation processing in the evaluation estimation engine 115.

Referring to FIG. 5, the evaluation estimation unit 115b of the evaluation estimation engine 115

(a) extracts, from, for example, the SNS period shift corrected totaling set accumulated in the post correction totaling storage unit 103, the post count information of SNS posts of the determined “document classification”, whose unit period has been shifted by the determined “period shift amount” and whose corresponding questionnaire totaling ID is k, and
(b) inputs the extracted post count information of the SNS posts to the “evaluation estimation model” generated by the estimation model construction unit 115a, and outputs, as an estimation value, the evaluation value (brand score) of the evaluation target (for example, “smartphone α”) in the group associated with k (questionnaire totaling ID) during the estimation target period.

The simplest configuration as a regression predictor in the “evaluation estimation model” is given as a brand score y (evaluation value) by:

y=a*x+b (5)

where x represents the SNS post count (during the unit period). The evaluation estimation model is determined by a and b in equation (5) above. Note that to optimize (learn) a and b as a model, it is necessary to prepare a number of sets of response variables y and predictor variables x.

By using, as the predictor variables x, data obtained by shifting the period, evaluation estimation is preferably performed by:

y=a₁*x(J(1,k))+a₂*x(J(2,k))+a₃*x(J(3,k))+ . . . +b (6)

where x(J(n, k)) represents the SNS post count of the record corresponding to the “period shift model J(n, k)”. In equation (6) above, N terms of aₙ*x(J(n, k)) each having a high correlation, that is, for n=1, 2, . . . , N can be provided. In equation (6), a₁, a₂, a₃, . . . , and b form the evaluation estimation model.

When estimating the evaluation value (brand score) using the evaluation estimation model of equation (6) above, a set of SNS post counts (as pieces of document information) belonging to each set of the determined “document classification” and “period shift amount” is input to the evaluation estimation model using the sets of the “document classifications (age/sex classifications and polarity classifications)” and “period shift amounts” determined in descending order of the correlation by the input record determination unit 114.

Referring to FIG. 5, the estimation model construction unit 115a of the evaluation estimation engine 115 establishes the evaluation estimation model using a number of sets each including

(a) the brand score (evaluation value) acquired from the questionnaire totaling set accumulated in, for example, the questionnaire totaling storage unit 102, and
(b) the SNS post count (document information) acquired from the SNS period corrected totaling set accumulated in, for example, the post correction totaling storage unit 103.
For example, in the case of equation (5) above, a and b forming the evaluation estimation model may be determined by, for example, the least-squares method. In the case of equation (6), a₁, a₂, a₃, . . . , and b forming the evaluation estimation model can be determined by, for example, the least-squares method.

Since the optimum values of the parameters a and b of equation (5) and the optimum values of the parameters a₁, a₂, a₃, . . . , and b of equation (6) change depending on k (questionnaire totaling ID), these parameters are preferably determined for each k.

Note that instead of the linear regression model indicated by equation (5) or (6), a nonlinear regression model such as NN (Neural Network) or SVR (Support Vector Regression) is used as the evaluation estimation model, thereby further improving the evaluation estimation accuracy.

For example, in SVR, a regression relationship is determined as follows. Let r be the residual between a sample and a regression line given by:

f(x)=xTw+b (7)

Then, an ε-insensitive error given by:

$$\begin{matrix}ξ ( r ) = 0 ( if \vert r \vert < ɛ ) \\ = \vert r \vert - ɛ ( otherwise )\end{matrix} \qquad ( 8 )$$

is used, and an optimization problem for samples (x₁, y₁), . . . , (x_{N}, y_{N}), given by:

min_{w,b}Σᵢ₌₁^{N}ξ(y₁−f(xᵢ))+λ∥w∥²/2 (9)

is considered, thereby determining the regression relationship. Note that λ represents a normalization parameter.

Note that equation (8) above is replaced by a quadratic programming problem given by:

min_{αi,α*i}εΣᵢ₌₁^{N}(α*ᵢ+α₁)−Σᵢ₌₁^{N}yᵢ(α*ᵢ−α₁)+½Σᵢ₌₁^{N}Σⱼ₌₁^{N}(α*ᵢ−α₁)(α*ⱼ−αⱼ)xᵢxⱼ (10)

Note that calculation is executed by imposing, on αᵢ and α*ᵢ, restrictions given by:

0≦αᵢ,α*ᵢ≦1/λ, and Σᵢ₌₁^{N}(α*ᵢ−α₁)=0 (11)

As described above, the evaluation estimation model generated by the estimation model construction unit 115a of the evaluation estimation engine 115 is not limited to that corresponding to equation (5) or (6). Estimation models in various forms based on various principles can be adopted.

[Another Embodiment of Apparatus Arrangement]

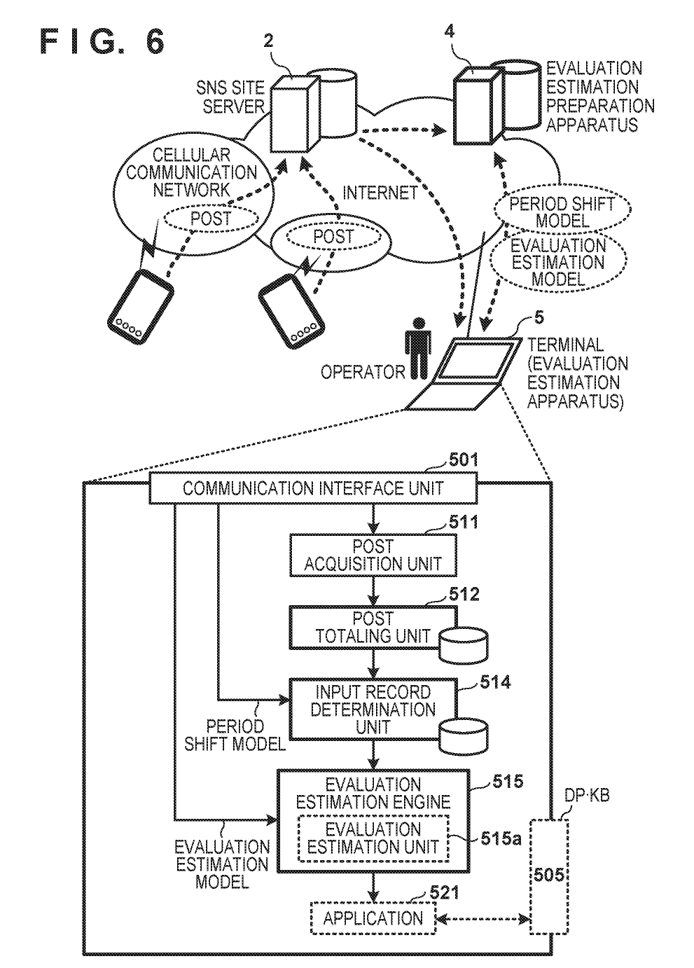

FIG. 6 is a functional block diagram showing the functional arrangement of another embodiment of the evaluation estimation apparatus according to the present invention.

Referring to FIG. 6, there are provided

(a) an evaluation estimation preparation apparatus 4 installed on the Internet, and
(b) a terminal 5, as an embodiment of the present invention, which is communicably connected to the evaluation estimation preparation apparatus 4.

The evaluation estimation preparation apparatus 4 includes functional components, interfaces, and storage units which are equivalent to those of the evaluation estimation apparatus 1 shown in FIG. 2. As a modification, a component corresponding to the evaluation estimation unit 115b for estimating an evaluation value may be omitted in the evaluation estimation preparation apparatus 4.

On the other hand, when compared to the evaluation estimation apparatus 1 shown in FIG. 2, the terminal 5 as the embodiment of the present invention includes neither of

(a) a component for generating a “period shift model J(n, k)”, that is, a component corresponding to the correlation determination unit 113 and the post correction totaling storage unit 103 (FIG. 2), and
(b) a component for generating an “evaluation estimation model”, that is, a component corresponding to the estimation model construction unit 115a and questionnaire totaling storage unit 102 (FIG. 2). Therefore, when compared to the evaluation estimation apparatus 1, an information processing amount executed in the apparatus is much smaller. In other words, the terminal 5 can implement evaluation estimation by the size and throughput of a portable terminal level.

More specifically, the terminal 5 includes a communication interface unit 501, a post acquisition unit 511 corresponding to the post acquisition unit 111 (FIG. 2), a post totaling unit 512 corresponding to the post totaling unit 112 (FIG. 2), an input record determination unit 514 corresponding to the input record determination unit 114 (FIG. 2), an evaluation estimation unit 515a corresponding to the evaluation estimation unit 115b (FIG. 2), an evaluation estimation engine 515 including no functional unit corresponding to the estimation model construction unit 115a (FIG. 2), an application 521, and a display/keyboard 505.

As described above, the terminal 5 includes no components for creating the “period shift model J(n, k)” and “evaluation estimation model”. However, the input record determination unit 514 and the evaluation estimation engine 515 can acquire the “period shift model J(n, k)” and “evaluation estimation model” from the evaluation estimation preparation apparatus 4 via the communication interface unit 501. Although the terminal 5 has the size and throughput of the portable terminal level, it can execute estimation of an evaluation value (brand score).

### Example

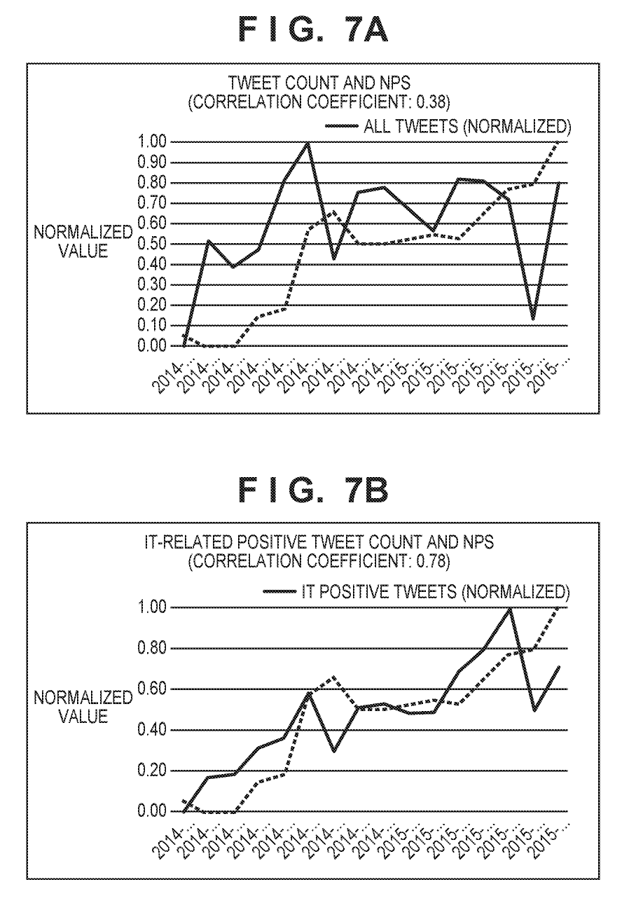

FIGS. 7A and 7B are graphs for explaining an example of the evaluation estimation method according to the present invention.

The graph of FIG. 7A shows transition of the total count (post count and comment count) of tweets on Twitter® as an SNS, each of which contains a keyword associated with one evaluation target, and transition of an NPS (Net Promotion Score) average value representing a quantified value of a brand image concerning the evaluation target. In this graph, the ordinate represents a value obtained by normalizing the tweet total count or NPS average value to a value ranging from 0 to 1. The totaling unit periods are the respective months in 2014 and 2015.

Referring to FIG. 7A, the correlation coefficient between the tweet total count and the NPS average value remains at 0.38. It is thus understood that it is very difficult to estimate the NPS of the evaluation target from the tweet count using this graph. This may be because much noise is included since tweets are simply totaled without considering the attributes of posters or post contents (polarities), and a shift between a tweet timing and a brand image establishment timing is not considered at all.

On the other hand, FIG. 7B is a graph showing, for the same evaluation target and totaling unit periods, transition of the NPS and transition of the total count (post count and comment count) of tweets to which the “period shift amount” and “document classification” determined after the “period shift model” is generated are applied according to the present invention. The determined “document classification” includes a classification indicating a tweet having a positive polarity for IT.

Referring to FIG. 7B, it is understood that the correlation coefficient between the tweet total count and the NPS average value reaches 0.78 and the tweet total count and the NPS average value have a high correlation. It is thus possible to appropriately estimate the NPS of the evaluation target from the period shift correction total count of tweets belonging to the applied “document classification (including the positive polarity for IT)” using the graph.

As is apparent from the example of FIG. 7B, according to the present invention, for example, it is possible to instantaneously predict, based on the SNS post count observed earlier, a brand image to be established later, by learning a shift in generation timing from the actual brand image with respect to the SNS post count (comment count) of various user attributes/polarities.

As described in detail above, according to the present invention, it is possible to estimate a more appropriate evaluation value according to the realities of image propagation by considering the time difference between a point of time at which document information (for example, an SNS post count) is generated and a point of time at which evaluation information (for example, a product/service (brand) image score) is generated, using the “period shift amount” determined based on the correlation between the pieces of information.

Particularly, in the embodiment considering the “document classification” of the document information, the document classification is set based on the user attributes and document contents (for example, the polarity), and the “period shift amount” determined in accordance with the document classification is used, thereby making it possible to estimate a more appropriate evaluation value according to the realities of the period shift for each “document classification”.

According to the present invention, in the field of marketing, it is possible to appropriately grasp an image of a specific product/service or brand during a given period by analyzing SNS posts which belong to the determined “poster attributes and post contents polarity” and have been corrected by the determined “period shift amount”. This can send/provide an advertisement for improving the image or a product/service of a new version to an appropriate target group during an appropriate period.

Various changes, modifications, and omissions can be easily made on the above-described various embodiments of the present invention within the technical idea and aspect of the present invention by those skilled in the art. The above description is merely an example, and is not intended to limit the present invention. The present invention is limited by only the scope of claims and their equivalents.

What is claimed is:

1. An evaluation estimation apparatus for estimating evaluation of a predetermined evaluation target based on a document acquired from a document set on a network and evaluation information concerning evaluation of the evaluation target that is acquired in advance, the apparatus comprising:
a document totaling unit configured to, for each predetermined unit period, associate, with the predetermined unit period, document information concerning a document which is generated during the predetermined unit period and related to the evaluation target; and
an evaluation estimation unit configured to use a period shift amount determined based on a degree of correlation between the document information whose associated unit period has been shifted by each of a plurality of shift amounts and the evaluation information acquired for each unit period to input document information of a document associated with a unit period that corresponds to an estimation target period when shifted by the determined period shift amount, and output an evaluation value of the evaluation target during the estimation target period.

2. The apparatus according to claim 1, further comprising:
a correlation determination unit configured to shift the unit period associated with the document information by each of the plurality of shift amounts, and then calculate, for each shift amount used for the shift operation, the correlation between the document information associated with each unit period and the evaluation information acquired for each unit period; and
an input record determination unit configured to determine the period shift amount based on the degree of correlation calculated for each shift amount.

3. The apparatus according to claim 1, wherein
the document totaling unit is further configured to, for each unit period for each of a plurality of preset document classifications, associate, with the unit period, document information concerning a document which is generated during the unit period, is related to the evaluation target, and belongs to the document classification, and
the evaluation estimation unit is further configured to use a document classification and a period shift amount determined based on the degree of correlation between document information whose associated unit period has been shifted by each of the plurality of shift amounts and which concerns a document belonging to each document classification and the evaluation information acquired for each unit period to input document information of a document which is associated with a unit period that corresponds to an estimation target period when shifted by the determined period shift amount and which belongs to the determined document classification, and output an evaluation value of the evaluation target during the estimation target period.

4. The apparatus according to claim 3, further comprising:
a correlation determination unit configured to shift the period unit associated with the document information by each of the plurality of shift amounts, and then calculate, for each shift amount used for the shift operation and each document classification, correlation between the document information associated with each unit period and the evaluation information acquired for each unit period; and
an input record determination unit configured to determine, based on the degree of correlation calculated for each shift amount and each document classification, a document classification associated with document information input to the evaluation estimation unit and a period shift amount to be used for the unit period associated with the document information.

5. The apparatus according to claim 4, wherein
the document classification is a classification about a document creation entity and/or document contents concerning evaluation,
the document totaling unit is further configured to generate a totaling set by associating information of a document creation entity classification and/or a document contents classification concerning evaluation with information, as document information, concerning the number of documents generated for each unit period, and
the correlation determination unit is further configured to generate a period shift totaling set in which an associated unit period of the number of generated documents in the generated totaling set has been shifted by each of the plurality of shift amounts.

6. The apparatus according to claim 4, wherein
the evaluation information is acquired for at least one evaluation classification about an evaluation entity and/or evaluation contents,
the correlation determination unit is further configured to calculate the correlation using evaluation information acquired for each evaluation classification assumed for evaluation of the evaluation target, and
the input record determination unit is further configured to determine a document classification and a period shift amount for each evaluation classification assumed for evaluation of the evaluation target.

7. The apparatus according to claim 6, wherein
the input record determination unit is further configured to determine at least one set of a document classification and a period shift amount in descending order of the calculated correlation, and
the evaluation estimation unit is further configured to estimate evaluation by inputting a set of pieces of document information belonging to each of the determined at least one set of the document classification and the period shift amount.

8. The apparatus according to claim 2, wherein the evaluation estimation unit is further configured to estimate evaluation of the evaluation target using an estimation model generated using document information whose associated unit period has been shifted by the period shift amount determined by the document totaling unit, the correlation determination unit, and the input record determination unit and the evaluation information associated with the same unit period as the unit period of a shift result.

9. A computer-readable storage medium storing a program executed by a computer mounted on an apparatus for estimating evaluation of a predetermined evaluation target based on a document acquired from a document set on a network and evaluation information concerning evaluation of the evaluation target that is acquired in advance, the program comprising:
an instruction for, for each unit period, associating, with the unit period, document information concerning a document which is generated during the unit period and related to the evaluation target; and
an instruction for using a period shift amount determined based on a degree of correlation between the document information whose associated unit period has been shifted by each of a plurality of shift amounts and the evaluation information acquired for each unit period to input document information of a document associated with a unit period that corresponds to an estimation target period when shifted by the determined period shift amount, and output an evaluation value of the evaluation target during the estimation target period.

10. An evaluation estimation method for an apparatus for estimating evaluation of a predetermined evaluation target based on a document acquired from a document set on a network and evaluation information concerning evaluation of the evaluation target that is acquired in advance, the method comprising:
for each unit period, associating, with the unit period, document information concerning a document which is generated during the unit period and related to the evaluation target; and
using a period shift amount determined based on a degree of correlation between the document information whose associated unit period has been shifted by each of a plurality of shift amounts and the evaluation information acquired for each unit period to input document information of a document associated with a unit period that corresponds to an estimation target period when shifted by the determined period shift amount, and output an evaluation value of the evaluation target during the estimation target period.
